(19) United States
(12) Patent Application Publication
(10) Pub. No.: US 2025/0132981 A1
(43) Pub. Date: Apr. 24, 2025

(54) NON-REAL-TIME DATA TRANSMISSION METHOD, DEVICE AND STORAGE MEDIUM

(71) Applicant: Qufu Normal University, Jining (CN)

(72) Inventors: Maoli WANG, Jining (CN); Kang WANG, Jining (CN); Bowen ZHANG, Jining (CN); Xinchang ZHANG, Jining (CN); Xiaodong ZANG, Jining (CN); Peng GAO, Jining (CN)

(21) Appl. No.: 19/007,818

(22) Filed: Jan. 2, 2025

Related U.S. Application Data
(63) Continuation of application No. PCT/CN2023/136098, filed on Dec. 4, 2023.

(30) Foreign Application Priority Data
Dec. 30, 2022 (CN) 202211731140.7

(51) Int. Cl. H04L 41/0896; H04L 47/762

(52) U.S. Cl. CPC H04L 41/0896; H04L 47/762

(57) ABSTRACT

The present invention provides a non-real-time data transmission method, including the following steps: periodically carrying out collaborative adjustment of the idle bandwidth occupation; and intermittently measuring an idle bandwidth between every two adjacent collaborative adjustment events of the idle bandwidth occupation and adjusting a data transmission rate according to the measurement results.

### CROSS-REFERENCE TO RELATED APPLICATIONS

This application is a continuation of PCT/CN2023/136098, filed on Dec. 4, 2023 and claims priority of Chinese Patent Application No. 202211731140.7, filed on Dec. 30, 2022, the entire contents of which are incorporated herein by reference.

### TECHNICAL FIELD

The disclosure relates to the technical field of data transmission, and in particular to a non-real-time data transmission method, a device and a storage medium.

### BACKGROUND

In recent years, non-real-time content transmission has been more and more widely used. Typical application scenarios include: online storage, such as Baidu network disk and Dropbox; content uploading and sharing, such as Kwai, YouTube, Instagram; instant messaging tools (such as QQ) off-line transmission and others. Non-real-time content transmission applications have a huge user base, and the huge non-real-time content traffic usually spans different network areas, which may easily lead to the congestion of the Internet, especially the backbone network links, and then affect the overall service quality of the Internet, especially the service quality of real-time content applications.

### SUMMARY

The technical problem to be solved by the disclosure is to provide a non-real-time data transmission method, device and storage medium aiming at the problems existing in the prior art.

In order to solve the technical problems, the disclosure provides a non-real-time data transmission method, including the following steps: periodically carrying out collaborative adjustment of idle bandwidth occupation; periodically measuring an idle bandwidth between every two adjacent collaborative adjustment events of the idle bandwidth occupation and adjusting a data transmission rate according to measurement results.

In order to solve the above technical problems, the disclosure also provides a non-real-time data transmission device, including a collaborative adjustment module and an idle bandwidth measurement module; the collaborative adjustment module is used for periodically carrying out collaborative adjustment of idle bandwidth occupation; the idle bandwidth measurement module is used for intermittently measuring an idle bandwidth between every two adjacent collaborative adjustment events of the idle bandwidth occupation and adjusting a data transmission rate according to measurement results.

In order to solve the above technical problems, the present disclosure also provides a computer-readable storage medium, including instructions, where when the instructions are run on a computer, the computer executes the non-real-time data transmission method provided by the above technical scheme.

In order to solve the above technical problems, the present disclosure also provides a non-real-time data transmission device, including a memory, a processor and a computer program stored in the memory and executable on the processor, where the processor implements the non-real-time data transmission method provided by the above technical scheme when executing the program.

The disclosure has the beneficial effects that by periodically carrying out collaborative adjustment of the idle bandwidth occupation, a plurality of path links sharing the same physical network will all obtain the right to use part of idle network resources, thus realizing that all data streams occupy network idle bandwidth resources fairly. In addition, an idle bandwidth is intermittently measured between every two adjacent collaborative adjustment events of the idle bandwidth occupation and a data transmission rate is adjusted according to measurement results, so as to make full use of bandwidth resources and avoid network congestion.

Additional aspects and advantages of the disclosure will be set forth in part in the description which follows, and in part will be obvious from the following description, or may be learned by practice of the disclosure.

### BRIEF DESCRIPTION OF THE DRA WINGS

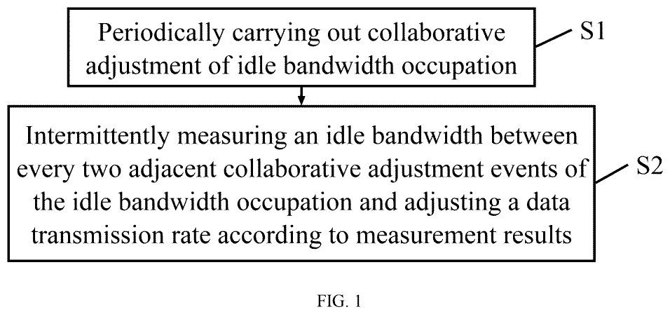

FIG. 1 is a flowchart of a non-real-time data transmission method provided by an embodiment of the present disclosure.

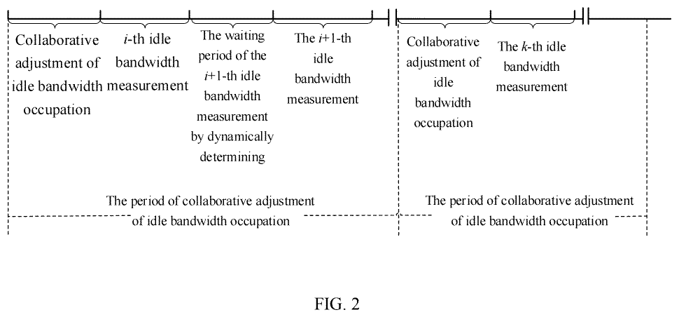

FIG. 2 is a schematic diagram of a mechanism for dynamically measuring idle bandwidth of non-real-time data transmission and coordinating adjustment of occupancy provided by an embodiment of the present disclosure.

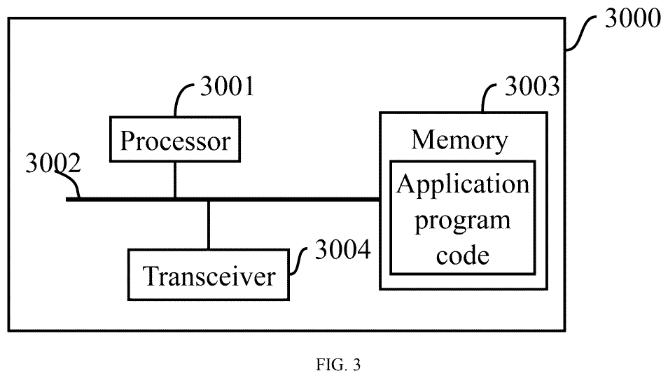

FIG. 3 is a schematic diagram of a non-real-time data transmission device provided by an embodiment of the present disclosure.

### DETAILED DESCRIPTION OF THE EMBODIMENTS

The following describes the implementation of the present disclosure through specific examples, and those skilled in the art may easily understand other advantages and effects of the present disclosure from the contents disclosed in this specification. Obviously, the described embodiment is only a part of the embodiments of the present disclosure, not the whole embodiments. This disclosure may also be implemented or applied through different specific embodiments, and various details in this specification may be modified or changed based on different viewpoints and applications without departing from the spirit of this disclosure. It should be noted that the following embodiments and features in the embodiments may be combined with each other without conflict. Based on the embodiments in this disclosure, all other embodiments obtained by ordinary technicians in this field without creative work belong to the protection scope of this disclosure.

It should be noted that various aspects of the embodiments within the scope of the appended claims are described below. It should be obvious that the aspects described herein may be embodied in a wide variety of forms, and any specific structure and/or function described herein is merely illustrative. Based on this disclosure, those skilled in the art should understand that one aspect described herein may be implemented independently of any other aspect, and two or more of these aspects may be combined in various ways. For example, devices and/or practice methods may be implemented using any number of aspects set forth herein. In addition, the apparatus and/or the method may be implemented with other structures and/or functionalities than one or more of the aspects set forth herein.

FIG. 1 is a flowchart of a non-real-time data transmission method provided by an embodiment of the present disclosure. As shown in FIG. 1, the method includes:
S1, periodically carrying out collaborative adjustment of idle bandwidth occupation;
S2, intermittently measuring an idle bandwidth between every two adjacent collaborative adjustment events of the idle bandwidth occupation and adjusting a data transmission rate according to measurement results.

The non-real-time data transmission method provided by the embodiment of the disclosure is a non-real-time data transmission rate cooperative adaptation method based on network idle resources, and a path idle bandwidth acquisition and occupation collaborative adjustment mechanism is adopted. As shown in FIG. 2, the mechanism periodically carries out collaborative adjustment of idle bandwidth occupation; when the data transmission is not in the collaborative adjustment of idle bandwidth occupation (that is, between every two adjacent collaborative adjustment events of the idle bandwidth occupation), the path idle bandwidth is measured periodically and the data transmission rate is adjusted according to the measurement results.

It should be noted that the data sender uses the path idle bandwidth measurement method to obtain the path idle bandwidth. The embodiment of the disclosure may adopt a measurement method based on packet interval, a measurement method based on rate or a measurement method based on probability to measure the path idle broadband.

The basic idea of path available bandwidth measurement based on packet interval is to inject some probe messages into the network, and calculate the bottleneck bandwidth and available bandwidth by analyzing the time when these messages enter and leave the network. Affected by the dynamic network load, the path available bandwidth measurement based on packet interval will have different results in different time periods.

In the rate-based path available bandwidth measurement, the sending end constantly increases the rate to send messages for detection. When the sending rate of the sending end is equal to the available bandwidth value, the average delay of the receiving end will be close to a constant.

Probability-based path may inject low-rate detection packets into the network by bandwidth measurement. Some detection packets do not need to be queued in the path, while others need to be queued. The proportion of detection packets that do not need to be queued represents the utilization rate of end-to-end path to a certain extent, so the path available bandwidth may be inferred.

In addition to the above three common methods for path available bandwidth measurement, there are also some other methods for path available bandwidth measurement, such as the path available bandwidth measurement based on a specific detection packet model. The path available bandwidth measurement based on specific detection packet model measurement collects path information by sending a small number of detection packets, and infers the path available bandwidth by combining model analysis.

According to the embodiment of the disclosure, by periodically carrying out collaborative adjustment of idle bandwidth occupation, a plurality of path link sharing the same physical link may obtain the right to use part of idle network resources, so that each data stream may occupy the idle bandwidth resources of the network fairly. In addition, an idle bandwidth is periodically measured between every two adjacent collaborative adjustment events of the idle bandwidth occupation and adjusting a data transmission rate according to measurement results, so that bandwidth resources are fully utilized and network congestion is avoided.

Optionally, between every two adjacent idle bandwidth measurement events, dynamically determining a waiting period of a next idle bandwidth measurement according to change of the idle bandwidth. Specifically, dynamically determining the waiting period of the next idle bandwidth measurement according to the change of the idle bandwidth, and a formula is as follows:

$${T}_{i + 1} = ρ \frac{1}{\vert {B}_{i} - {B}_{i - 1} \vert + 1}$$

where Tᵢ₊₁ represents a waiting time of an i+1-th idle bandwidth measurement, Bᵢ and Bᵢ₋₁ are idle bandwidth values obtained from an i-th and an i−1-th idle bandwidth measurement respectively, and p is a configuration parameter, and is a constant.

Assuming that Tᵢ₊₁ represents the waiting time of the i+1-th idle bandwidth measurement, and Bᵢ and Bᵢ₋₁ are idle bandwidth values obtained from an i-th and an i−1-th idle bandwidth measurement respectively, Tᵢ₊₁ may be set as:

$${T}_{i + 1} = ρ \frac{1}{\vert {B}_{i} - {B}_{i - 1} \vert + 1}$$

where ρ is the configuration parameter, and by default ρ=3 (minutes). The above settings mean that when the idle bandwidth is basically unchanged, the next idle bandwidth measurement needs to wait for 3 minutes. When the idle bandwidth changes greatly, the value of Tᵢ₊₁ becomes smaller, so as to make full use of bandwidth resources or avoid network congestion.

During the waiting period for the next idle bandwidth measurement, the actual transmission rate of the path is monitored, and if the actual transmission rate meets or exceeds the current rate limit value, the next idle bandwidth measurement is triggered earlier to ensure timely adjustment of the data transmission rate and efficient utilization of idle bandwidth resources. In any case, the time interval between two adjacent idle bandwidth acquisitions should not be lower than the specified threshold, so as to avoid too frequent idle bandwidth measurement actions. When it is not in the collaborative adjustment period of the idle bandwidth occupation, the data transmission rate is adjusted to the corresponding values of the measurement results after obtaining the measurement results of the path idle bandwidth every time.

The embodiment of the disclosure dynamically formulates a relatively relaxed waiting period according to the change of idle bandwidth, thus effectively solving the contradiction that the longer the waiting time between every two adjacent idle bandwidth acquisition events, the smaller the idle bandwidth acquisition load, but the worse the timeliness of idle bandwidth information in the path idle bandwidth acquisition and occupation collaborative adjustment mechanism.

Because multiple paths may share the same physical link, limiting the transmission rate independently by each path sometimes leads to some paths being delayed in obtaining the right to use idle bandwidth or only getting a small amount of the right. Now, the above problems will be explained through the following scenarios: assuming that the paths corresponding to the two sessions are p₁ and p₂, respectively, and p₁ and p₂ share the same bottleneck physical link, where p₁ obtains the idle bandwidth before p₂ and arranges the transmission rate based on the idle bandwidth. When it is necessary to use the path p₂ to transmit data, the shared bottleneck physical link bandwidth resources will be occupied, so effective idle bandwidth cannot be obtained, which is not conducive to improving the overall service quality of the network. In order to solve the above problems, each path in the embodiment of the disclosure actively adjusts the idle bandwidth occupation at intervals (which may be configured according to requirements, such as 3 minutes). Every time the idle bandwidth is adjusted, the transmission rate is gradually increased every specified time (such as 30 seconds) by an exponential function (t^{a}, where t represents time, and a=2 in the case of default); the duration of idle bandwidth occupation adjustment is dynamically adjusted according to the task quantity and task execution. When the transmission rate is gradually increased, each data transmission will obtain part of the right to use idle network resources, thus realizing the fair occupation of idle network bandwidth resources by each data stream. In addition, due to the exponential growth function, the idle bandwidth resources of the network may be used quickly as a whole.

The embodiment of the disclosure also provides a non-real-time data transmission device, which includes a collaborative adjustment module and an idle bandwidth measurement module. The collaborative adjustment module is used for periodically carrying out collaborative adjustment of idle bandwidth occupation; the idle bandwidth measurement module is used for intermittently measuring an idle bandwidth between every two adjacent collaborative adjustment events of the idle bandwidth occupation and adjusting a data transmission rate according to measurement results.

It should be noted that the data sender uses the path idle bandwidth measurement method to obtain the path idle bandwidth. The embodiment of the disclosure may adopt a measurement method based on packet interval, a measurement method based on rate or a measurement method based on probability to measure the path idle broadband.

The basic idea of path available bandwidth measurement based on packet interval is to inject some probe messages into the network, and calculate the bottleneck bandwidth and available bandwidth by analyzing the time when these messages enter and leave the network. Affected by the dynamic network load, the path available bandwidth measurement based on packet interval will have different results in different time periods. In the rate-based path available bandwidth measurement, the sending end constantly increases the rate to send messages for detection. When the sending rate of the sending end is equal to the available bandwidth value, the average delay of the receiving end will be close to a constant. When the sending rate of the sending end is equal to the available bandwidth value, the average delay of the receiving end will be close to a constant.

In addition to the above three common methods for path available bandwidth measurement, there are also some other methods for path available bandwidth measurement, such as the path available bandwidth measurement based on a specific detection packet model. The path available bandwidth measurement based on specific detection packet model measurement collects path information by sending a small number of detection packets, and infers the path available bandwidth by combining model analysis.

According to the embodiment of the disclosure, by periodically carrying out collaborative adjustment of idle bandwidth occupation, a plurality of path link sharing the same physical link may obtain the right to use part of idle network resources, so that each data stream may occupy the idle bandwidth resources of the network fairly. In addition, an idle bandwidth is periodically measured between every two adjacent collaborative adjustment events of the idle bandwidth occupation and adjusting a data transmission rate according to measurement results, so that bandwidth resources are fully utilized and network congestion is avoided.

Optionally, the idle bandwidth measurement module is specifically used to dynamically determine the waiting period of the next idle bandwidth measurement between every two adjacent idle bandwidth measurement events according to the change of idle bandwidth. Specifically, the waiting period for the next idle bandwidth measurement is dynamically determined according to the change of idle bandwidth, and the formula is as follows:

$${T}_{i + 1} = ρ \frac{1}{\vert {B}_{i} - {B}_{i - 1} \vert + 1}$$

where, Tᵢ₊₁ represents a waiting time of an i+1-th idle bandwidth measurement, Bᵢ and Bᵢ₋₁ are idle bandwidth values obtained from an i-th and an i−1-th idle bandwidth measurement respectively, and p is a configuration parameter, and is a constant.

Assuming that Tᵢ₊₁ represents the waiting time of the i+1-th idle bandwidth measurement, and Bᵢ and Bᵢ₋₁ are idle bandwidth values obtained from an i-th and an i−1-th idle bandwidth measurement respectively, Tᵢ₊₁ may be set as:

$${T}_{i + 1} = ρ \frac{1}{\vert {B}_{i} - {B}_{i - 1} \vert + 1}$$

where ρ is the configuration parameter, and by default ρ=3 (minutes). The above settings mean that when the idle bandwidth is basically unchanged, the next idle bandwidth measurement needs to wait for 3 minutes. When the idle bandwidth changes greatly, the value of Tᵢ₊₁ becomes smaller, so as to make full use of bandwidth resources or avoid network congestion.

During the waiting period of the next idle bandwidth measurement, the actual transmission rate of the path is obtained. When the actual transmission rate of the path is greater than or equal to the current rate limit value, the next idle bandwidth measurement is forced in advance, so that the transmission rate may be adjusted in time to make full use of idle network resources. In any case, the time interval between two adjacent idle bandwidth acquisitions should not be lower than the specified threshold, so as to avoid too frequent idle bandwidth measurement actions. When it is not in the collaborative adjustment period of the idle bandwidth occupation, the data transmission rate is adjusted to the corresponding value of the measurement result after obtaining the measurement results of the path idle bandwidth every time. The data transmission rate during the idle bandwidth measurement may keep the current transmission rate unchanged.

The embodiment of the disclosure dynamically formulates a relatively relaxed waiting period according to the change of idle bandwidth, thus effectively solving the contradiction that the longer the waiting time between every two adjacent idle bandwidth acquisition events, the smaller the idle bandwidth acquisition load, but the worse the timeliness of idle bandwidth information in the path idle bandwidth acquisition and occupation collaborative adjustment mechanism.

Optionally, the collaborative adjustment module is used to gradually increase the transmission rate through an exponential function during the collaborative adjustment period of idle bandwidth occupation. The exponential function is t^{a}, t represents time, and a is constant.

Because multiple paths may share the same physical link, limiting the transmission rate independently by each path sometimes leads to some paths being delayed in obtaining the right to use idle bandwidth or only getting a small amount of the right. Now, the above problems will be explained through the following scenarios: assuming that the paths corresponding to the two sessions are p₁ and p₂, respectively, and p₁ and p₂ share the same bottleneck physical link, where p₁ obtains the idle bandwidth before p₂ and arranges the transmission rate based on the idle bandwidth. When it is necessary to use the path p₂ to transmit data, the shared bottleneck physical link bandwidth resources will be occupied, so effective idle bandwidth cannot be obtained, which is not conducive to improving the overall service quality of the network. In order to solve the above problems, each path in the embodiment of the disclosure actively adjusts the idle bandwidth occupation at intervals (which may be configured according to requirements, such as 3 minutes). Every time the idle bandwidth is adjusted, the transmission rate is gradually increased by an exponential function (t^{a}, where t represents time, and a=2 in the case of default). When the transmission rate is gradually increased, each data transmission will obtain part of the right to use idle network resources, thus realizing the fair occupation of idle network bandwidth resources by each data stream. In addition, due to the exponential growth function, the idle bandwidth resources of the network may be used quickly as a whole.

An embodiment of the present disclosure also provides a computer-readable storage medium, including instructions, where when the instructions are run on a computer, the computer executes the non-real-time data transmission method provided by the above embodiment.

As shown in FIG. 3, the embodiment of the present disclosure also provides a non-real-time data transmission device 3000, which includes a processor 3001, a memory 3003, and a computer program stored in the memory 3003 and running on the processor 30001. When the processor 3001 executes the program, the non-real-time data transmission method provided in the above embodiment is realized.

The processor 3001 and the memory 3003 are connected, for example, by a bus 3002. Optionally, the electronic device 3000 may also include a transceiver 3004, which may be used for data interaction between the electronic device and other electronic devices, such as data transmission and/or data reception. It should be noted that there is not only one transceiver 3004 in practical application, and the structure of the electronic device 3000 does not constitute a limitation to the embodiment of the present disclosure.

The processor 3001 may be a CPU (Central Processing Unit), a general processor, a DSP (Digital Signal Processor), an ASIC (Application Specific Integrated Circuit), FPGA (Field Programmable Gate Array) or other programmable logic devices, transistor logic devices, hardware components or any combination thereof, which may implement or perform various illustrative logical blocks, modules and circuits described in connection with the present disclosure. The processor 3001 may also be a combination for realizing computing functions, for example, including one or more microprocessor combinations, DSP and microprocessor combinations, etc.

The bus 3002 may include a path to transfer information between the above components. The bus 3002 may be a PCI (Peripheral Component Interconnect) bus or an EISA (Extended Industry Standard Architecture) bus. Bus 3002 may be divided into address bus, data bus, control bus, etc. For convenience of representation, only one thick line is used in FIG. 3, but it does not mean that there is only one bus or one type of bus.

The memory 3003 may be ROM (Read Only Memory) or other types of static storage devices that may store static information and instructions, RAM (Random Access Memory) or other types of dynamic storage devices that may store information and instructions. The memory 3003 may also be EEPROM (Electrically Erasable Programmable Read Only Memory), CD-ROM (Compact Disc Read Only Memory) or other optical storage, optical storage (including compact disc, laser disc, optical disc, digital versatile disc, Blu-ray disc, etc.), magnetic storage medium or other magnetic storage devices, or any other medium that may be used to carry or store desired program codes in the form of instructions or data structures and may be accessed by a computer, but is not limited to this.

The memory 3003 is used to store application program codes (computer programs) for implementing the scheme of the present disclosure, and the execution is controlled by the processor 3001. The processor 3001 is used to execute the application program code stored in the memory 3003 to realize the contents shown in the aforementioned method embodiment.

It may be clearly understood by those skilled in the art that for the convenience and conciseness of description, the specific working process of the installation and unit described above may refer to the corresponding process in the aforementioned method embodiment, and will not be repeated here.

In several embodiments provided by this application, it should be understood that the disclosed devices and methods may be realized by other ways. For example, the device embodiment described above is only schematic. For example, the division of units is only a logical function division. In actual implementation, there may be other division methods, such as multiple units or components may be combined or integrated into another system, or some features may be ignored or not implemented.

The units described as separate components may or may not be physically separated, and the components displayed as units may or may not be physical units, that is, they may be located in one place or distributed to multiple network units. Some or all of the units may be selected according to actual needs to achieve the purpose of the embodiment of the disclosure.

In addition, each functional unit in each embodiment of the present disclosure may be integrated into one processing unit, or each unit may exist physically alone, or two or more units may be integrated into one unit. The above integrated units may be realized in the form of hardware or software functional units.

Integrated units may be stored in a computer-readable storage medium if they are implemented in the form of software functional units and sold or used as independent products. Based on this understanding, the technical scheme of the present disclosure is essentially a part that has contributed to the prior art, or all or part of the technical scheme may be embodied in the form of a software product, which is stored in a storage medium and includes several instructions to make a computer device (which may be a personal computer, a server, a network device, etc.) execute all or part of the steps of the methods of various embodiments of the present disclosure. The aforementioned storage media include: U disk, mobile hard disk, Read-Only Memory (ROM), Random Access Memory (RAM), magnetic disk or optical disk and other media that may store program codes.

The above is only the preferred embodiment of the disclosure, and it is not used to limit the disclosure. Any modification, equivalent substitution, improvement, etc. made within the spirit and principle of the disclosure should be included in the protection scope of the disclosure.

What is claimed is:

1. A non-real-time data transmission method for improving idle bandwidth usage and data transmission across multiple link paths shared by the same physical network, comprising:
carrying out a collaborative adjustment of an idle bandwidth occupation periodically for a plurality of links paths sharing the same physical link to obtain an idle network resources, wherein: during the collaborative adjustment period of the idle bandwidth occupation, a transmission rate is gradually increased by an exponential function; and each collaborative adjustment event indicates that each data stream occupies the idle bandwidth resources;
measuring an idle bandwidth intermittently between every two adjacent collaborative adjustment events, wherein the measurement comprises: injecting probe messages into the network to obtain bottleneck bandwidth and available bandwidth based on packet intervals, rate-based detection, or probability-based methods; and optionally using path-specific detection packet models to infer the path's available bandwidth with minimal probe overhead of the idle bandwidth occupation; and
adjusting a data transmission rate based on the measured idle bandwidth results obtained during intermittent measurements;
wherein between every two adjacent idle bandwidth measurement events, determining a waiting period for the next idle bandwidth measurement between every two adjacent idle bandwidth measurement events according to changes in the idle bandwidth.

2. The non-real-time data transmission method according to claim 1, wherein determining the waiting period of the next idle bandwidth measurement according to the change of the idle bandwidth, and a formula is as follows:
$${T}_{i + 1} = ρ \frac{1}{\vert {B}_{i} - {B}_{i - 1} \vert + 1}$$
wherein Tᵢ₊₁ represents a waiting time of an i+1-th idle bandwidth measurement, Bᵢ and Bi−1 are idle bandwidth values obtained from an i-th and an i−1-th idle bandwidth measurement respectively, and p is a configuration parameter, and is a constant.

3. The non-real-time data transmission method according to claim 1, wherein during the waiting period for the next idle bandwidth measurement, the transmission rate of the path is monitored, and if the transmission rate meets or exceeds the current rate limit value, the next idle bandwidth measurement is triggered earlier for timely adjustment of the data transmission rate and efficient utilization of idle bandwidth resources.

4. The non-real-time data transmission method according to claim 1, wherein the exponential function is t^{a}, t represents time, and a is a constant.

5. The non-real-time data transmission method according to claim 4, wherein a value of a is 2.

6. A non-real-time data transmission device, comprising:
a collaborative adjustment module, used for periodically carrying out collaborative adjustment of idle bandwidth occupation; during a collaborative adjustment period of the idle bandwidth occupation, gradually increasing a transmission rate by an exponential function; and
an idle bandwidth measurement module, used for intermittently measuring an idle bandwidth between every two adjacent collaborative adjustment events of the idle bandwidth occupation and adjusting a data transmission rate according to measurement results;
wherein between every two adjacent idle bandwidth measurement events, dynamically determining a waiting period of a next idle bandwidth measurement according to change of the idle bandwidth.

7. A computer-readable storage medium, comprising instructions, wherein when the instructions are run on a computer, the computer executes the non-real-time data transmission method according to claim 1.

8. A non-real-time data transmission device, comprising a memory, a processor and a computer program stored in the memory and executable on the processor, wherein the processor implements the non-real-time data transmission method according to claim 1 when executing the program.
